(19) United States
(12) Patent Application Publication
(10) Pub. No.: US 2004/0196530 A1
(43) Pub. Date: Oct. 7, 2004

(54) Stimulated spin-flip raman optical amplifier

(76) Inventors: Jeffrey H. Hunt, Chatsworth, CA (US); Robert J. Atmur, Whittier, CA (US)

Correspondence Address: WILLIAM C. ANDERSON, THE BOEING COMPANY, 15460 LAGUNA CANYON ROAD, MC 1650-7009, IRVINE, CA, 92618, US

(21) Appl. No.: 10/382,596

(22) Filed: Mar. 6, 2003

(51) Int. Cl. H01S 3/00

(52) U.S. Cl. 359/334

(57) ABSTRACT

The stimulated spin-flip Raman scattering optical amplifier includes a first control optics assembly, a driver element, a second control optics assembly, a spin-flip Raman active medium and egressing optics. The first control optics assembly receives an incoming laser beam and adjusts that incoming laser beam in accordance with first desired wavelength, polarization and beam propagation parameters. A driver element produces a driver laser beam. A second control optics assembly receives the driver laser beam and adjusts that driver laser beam in accordance with second desired wavelength, polarization and beam propagation parameters. A spin-flip Raman active medium receives an output from the first control optics assembly and an output from the second control optics assembly. The spin-flip Raman active medium provides a non-linear optical interaction between the outputs such that the incoming laser beam is amplified, producing an amplified spin-flip Raman active medium output laser beam and a depleted driver laser beam. Egressing optics receives the amplified spin-flip Raman active medium output laser beam and the depleted driver laser beam. The egressing optics controllably transmits the amplified spin-flip Raman active medium output laser beam in accordance with third desired wavelength, polarization, and beam propagation parameters and prevents transmission of the depleted driver laser beam. The output of the egressing optics includes an amplified egressing optics output laser beam.

### BACKGROUND OF THE INVENTION

1. Field of the Invention

This invention relates to optical amplifiers and more particularly to an optical amplifier that uses stimulated spin-flip Raman scattering for providing optical amplification.

2. Description of the Related Art

The field of optical signal amplifiers has been generally dominated by Raman amplifiers. For example, U.S. Pat. No. 3,414,354, issued to E. H. Siegler Jr., entitled Raman Spectrometers, is a seminal publication disclosing the use of stimulated Raman scattering, to provide optical amplification. In a later example, U.S. Pat. No. 3,515,897, issued to W. H. Culver, entitled Stimulated Raman Parametric Amplifier, discloses a design for implementing stimulated Raman scattering for amplification.

Use of Raman scattering for optical signal amplification has limitations in its operation and implementation. Examination of the equations that govern stimulated Raman scattering break down into two terms. The first term is associated with the wave that is being amplified, also known as the Stokes wave. The second term is associated with a material excitation that is a product of the Raman scattering. Consequently, stimulated Raman scattering can be considered as a parametric or coupled generation process in which the optical pump wave generates a Stokes wave (i.e. the amplified input) and a material excitation wave. This material excitation wave is part of the coupled wave physical process which allows the input beam to be amplified. The frequency of the material excitation is set by the material in use. This excitation cannot vary, as it arises from a vibrational state that is both infrared and Raman active. The material excitation frequency imposes a strict frequency relation between the pump and input beams. In many applications, either the input or pump is set by other technical requirements, such as optical power or frequency compatibility, which severely limits the flexibility of the amplifier.

In addition, another inherent difficulty with Raman scattering is that the material excitation itself is a high energy excitation. In order to use a Raman active medium for amplification, the optical implementation is constrained to excite the material parameter inherent to the medium. These excitations are associated with vibrational resonances in the infrared segment of the electromagnetic spectrum. The associated wavelengths of these excitations will be in the 3 to 10 micron regime. A typical amplifier beam will be in the mid-visible, at a wavelength of approximately 0.5 micron. Consequently, 10% of the pump beam will be lost to the material excitation, even if the optical system is lossless otherwise. For high power long term operation, this is a considerable loss.

A spin-flip Raman laser uses a semiconductor that is placed in a magnetic field. Each energy level of an electron in the solid splits into two, one energy for an electron with spin parallel to the magnetic field and the other with spin antiparallel. When there is a transition involving Raman scattering of radiation the electron spin changes its direction. The wavelength of the laser is varied by changing the magnetic field. Tuning over a range of several micrometers in the infrared is possible. In Applied Physics Letters, Vol. 17, No. 11(1970), pgs. 481-483, Mooradian et. al. discuss the first continuous wave operation of a Raman laser. This laser operation was based on stimulated scattering from electron spin-flip excitations in InSb. In Applied Physics Letters, Vol. 18, No. 6 (1971), pgs. 229-230, Brueck et al discuss operation of the same lnSb laser, but operated with single longitudinal and transverse modes, which produce greater optical efficiency. In Physical Review Letters, Vol. 28, No. 11 (1972), pgs. 648-652 (1972), Patel et al discuss the narrow linewidth associated with a spin-flip laser. In Physical Review Letters, Vol. 28, No. 22 (1972), pgs. 1458-1461, Brueck et al also discuss the narrow linewidth of the spin-flip laser and examine the behavior as a function of the magnetic splitting field and scattering geometry. In Applied Physics Letters, Vol. 22 (1973), pgs. 543-545, DeSilets et al discuss operation of a spin-flip InSb laser with an optimized optical system which produced energy conversion efficiencies up to 80%.

### SUMMARY

In a broad aspect, the stimulated spin-flip Raman scattering optical amplifier of the present invention includes a first control optics assembly, a driver element, a second control optics assembly, a spin-flip Raman active medium and egressing optics. The first control optics assembly receives an incoming laser beam and adjusts that incoming laser beam in accordance with first desired wavelength, polarization and beam propagation parameters. A driver element produces a driver laser beam. A second control optics assembly receives the driver laser beam and adjusts that driver laser beam in accordance with second desired wavelength, polarization and beam propagation parameters. A spin-flip Raman active medium receives an output from the first control optics assembly and an output from the second control optics assembly. The spin-flip Raman active medium provides a non-linear optical interaction between the outputs such that the incoming laser beam is amplified producing an amplified spin-flip Raman active medium output laser beam and a depleted driver laser beam. Egressing optics receives the amplified spin-flip Raman active medium output laser beam and the depleted driver laser beam. The egressing optics controllably transmits the amplified spin-flip Raman active medium output laser beam in accordance with third desired wavelength, polarization and beam propagation parameters and prevents transmission of the depleted driver laser beam. The output of the egressing optics includes an amplified egressing optics output laser beam.

The use of spin-flip Raman scattering allows parametric amplification of a weak signal without the strict signal frequency versus pump frequency constraints associated with Raman scattering. Furthermore, it allows parametric amplification of a weak signal with considerably less energy loss to the excitation-coupling medium than Raman scattering. These features improve the technical flexibility of the overall system, allowing more options for its implementation. This has the potential to offer simpler optical designs than that associated with the Raman process. Further, the overall system operation is more energy efficient. It reduces the amount of engineering and design necessary to remove the large amount of waste heat associated with the Raman process. As a result, the hardware associated with the use of this amplifier in an optical system, such as an optical communication system, minimizes volume and weight.

### BRIEF DESCRIPTION OF THE DRAWINGS

FIG. 1 is a schematic view of a preferred embodiment of the stimulated spin-flip Raman scattering optical amplifier of the present invention.

FIG. 2 shows an energy excitation diagram associated with a spin-flip wave.

FIG. 3 is a schematic view of a communication system implementing a stimulated spin-flip Raman scattering optical amplifier in accordance with the principles of the present invention.

### DETAILED DESCRIPTION OF THE INVENTION

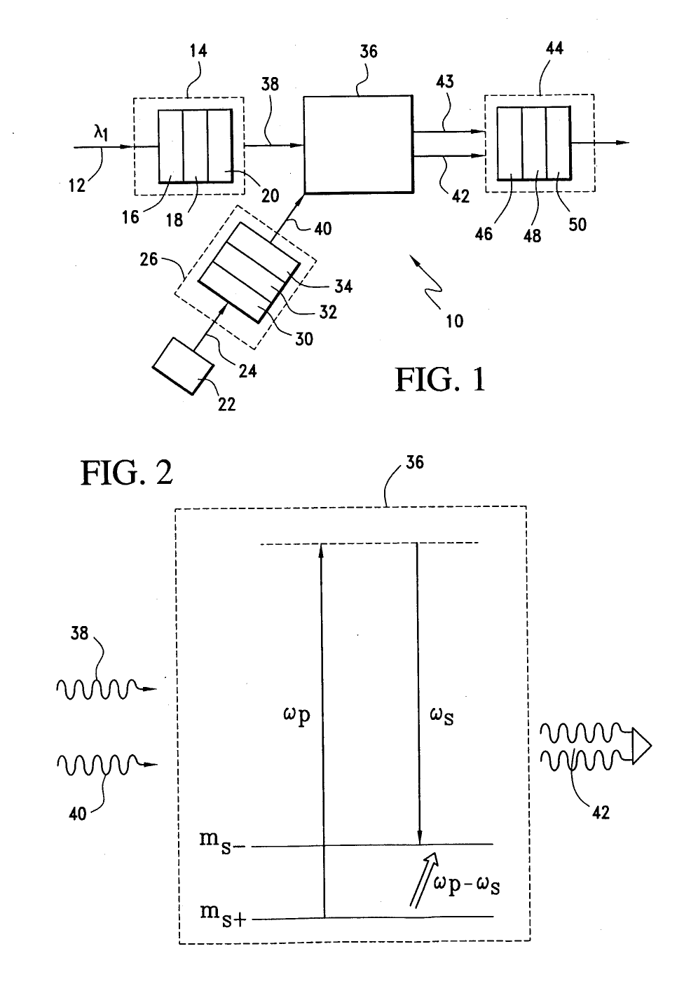

Referring to the drawings and the characters of reference marked thereon, FIG. 1 illustrates a preferred embodiment of the present invention, designated generally as 10. An incoming laser beam 12 is received by a first control optics assembly, designated generally as 14. The laser beam, λ₁, may be generally described as an electromagnetic or light beam with a single narrow wavelength in the optical regime (0.1-10 microns), which is propagating in a uniform well-defined direction, made possible by its coherence properties. The laser beam could represent an image or could be a digitally encoded optical beam for data transmission.

The first control optics assembly 14 adjusts the incoming laser beam in accordance with desired wavelength, polarization and beam propagation parameters. These parameters can include, for example, precise wavelength filtering to the expected signal wavelength, the optical bandwidth of the incoming signal or the polarization of the light. The wavelength may be controlled to fit within the transparency range of the ensuing steerer. It may be more precisely filtered to fit a known input signal, either from an image or from a digitally encoded communication beam.

The assembly 14 preferably includes a wavelength control element 16 such as a color filter, an etalon, a Fabry-Perot interferometer, a Fizeau interferometer, a diffraction grating, or a notch filter, etc. A polarization control element 18 polarizes the wavefront. This may comprise, for example, a polarization plate, a Brewster's angle polarizer, or a thin film polarizer. The precise polarizer to be selected depends on the particular application's engineering requirements such as polarization rejection ratio, size and weight of the polarizer, and the wavelength range over which the steerer must operate, etc. The wavefront is then received by a propagation control element 20 such as a single lens, double lens, refractive elements, reflective elements or other system up to a fully engineered telescope.

A driver element 22, for encoding, produces a driver laser beam 24. The driver element 22 may comprise, for example, a single frequency laser, with sufficiently high intensity to affect a nonlinear optical interaction with the incoming beam described previously. This could be a solid state laser, a high power diode laser or other suitable high intensity laser.

A second control optics assembly 26 adjusts the driver laser beam 24 in accordance with desired wavelength, polarization and beam propagation parameters. The assembly 26 preferably includes wavelength control element 30, such as a color filter, an etalon, a Fabry-Perot interferometer, a Fizeau interferometer, a diffraction grating or a notch filter. A polarization control element 32 and a propagation control element 34 are utilized, as described above.

A spin-flip Raman active medium 36 receives an output 38 from the first control optics assembly 14 and an output 40 from the second control optics assembly 26. The spin-flip Raman active medium 36 provides a non-linear optical interaction between the outputs 38, 40 such that an amplified spin-flip Raman active medium output laser beam 42 and a depleted driver laser beam 43 are provided. Using stimulated spin-flip Raman scattering as a means of amplification provides enhanced flexibility in the amplification process. In this process, as in all stimulated processes, there is a material excitation present as the physical entity that couples the pump and signal waves. However, in this case, the excitation is a spin wave in the medium in question. With the application of a magnetic field, the conduction band in the solid splits into two states. The upper and lower states correspond to electron spin states that are antiparallel and parallel to the magnetic field, respectively. The material excitation corresponds to a flip from lower to upper energy states. This excitation acts as the medium that couples the input and amplifying frequencies.

The energy diagram associated with a spin-flip wave is shown in FIG. 2. An external magnetic field is applied to the spin-flip medium 36. As shown in the figure, there are two energy states, mₛ₋ and mₛ₊, which correspond to the electron spin, being antiparallel or parallel to the magnetic field, respectively. The energy splitting between the spin levels is given by the Zeeman splitting, 2μ_{B}gB, where μ_{B} is the magnetic polarizibility, g is the lineshape for the excitation, and B is the applied magnetic field. The energy of the splitting and consequently, the spin-flip excitation, can be tuned over a broad range. This gives a stimulated spin-flip scattering amplifier two distinct advantages in its application over other parametric amplifiers. The material excitation can be minimized so that less energy is lost to the material than other excitation methods, reducing requirements on heat removal and making the optical system lower volume and lower weight. Also, the material excitation can be chosen to match the frequency difference between the pump laser and signal (ωₚ−ωₛ). This leads to simpler optical engineering constraints on the pump laser and supporting optical elements.

The gain coefficient for the stimulated spin-flip Raman process is given in Chapter 10 of Principles of Nonlinear Optics by Y. R. Shen. Quoted here, the gain coefficient, G_{SF}, is given by

$${G}_{SF} = N \frac{4 {π}^{2} {c}^{3} {ϵ}_{p}}{{ω}_{p} {ω}_{s}^{2} {ϵ}_{s} {ρ}_{i}} ( {ρ}_{i} - {ρ}_{f} ) ( \frac{ⅆ σ}{ⅆ Ω} ) {\vert {E}_{p} \vert}^{2} g ( ( \frac{h}{2 π} ) Δω ) ,$$

, where N is the density of spin-flip scatterers, ωₛ is the input frequency, ωₚ is the spin-flip excitation frequency, c is the speed of light, ∈ₚ and ∈ₛ are the dielectric values at pump and signal frequencies respectively, ρᵢ and ρ_{f} are initial and final state number densities, dσ/dΩ is the spin-flip scattering cross section, g((h/2π)Δω) is the lineshape as a function of frequency detuning, Δω, and |Eₚ| is the absolute magnitude of the pump laser.

The driver output 40 enters the spin-flip Raman active medium 36 along with the weak beam 38 whose intensity is to be amplified. Via the material coupling within the stimulated spin-flip scattering, energy is transferred from the pump or driver beam 43 to the weak beam 38. The material excitation present, as the physical entity that couples the pump and signal waves, is a spin-flip wave. A typical frequency shift associated with a spin-flip event is tunable and can range from 1 cm⁻¹ to 300 cm⁻¹. The physical process that leads to the growth of the spin-flip wave also leads to the growth of the weak beam 38, as the wave processes are coupled.

Examples of spin-flip Raman active media include condensed matter polar crystals. Examples of these include GaP, LiNbO₃, Hg_{0.77}Cd_{0.23}Te and Pb_{0.88}Sn_{0.12}Te. Other manufactured nonlinear media, such as periodically poled LiNbO₃ or periodically poled KDP, may be used as this amplification media. Other suitable materials include fiber optical materials that are capable of supporting the formation and propagation of spin-flip Raman excitations. Such materials allow good efficiency in the nonlinear optical interaction.

Egressing optics 44 receives the output 42 of the spin-flip Raman active medium 36 and adjusts that laser beam in accordance with desired wavelength, polarization and beam propagation parameters. The output of the egressing optics has the laser beam propagation direction shifted relative to the incoming laser beam direction. Egressing optics 44 includes an egressing wavelength control element 46, an egressing propagation control element 48 and an egressing polarization control element 50. These components may be as discussed above with respect to assemblies 14 and 26.

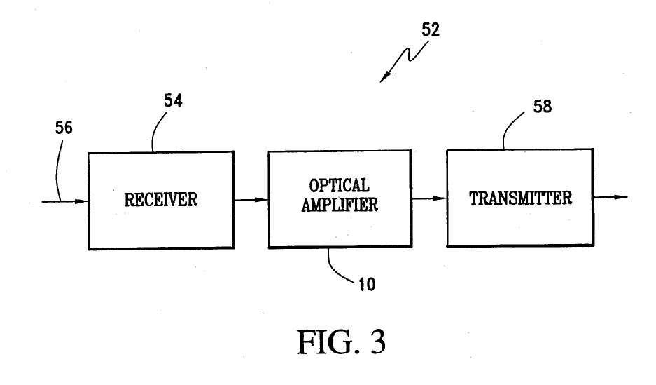

Referring now to FIG. 3, integration of the stimulated spin-flip Raman scattering optical amplifier 10 of the present invention is illustrated into an optical communication system, designated generally as 52. The communication system 52 includes an optical receiver 54 that receives a relatively weak signal 56 entering via, for example, a fiber or free space. The receiver 54 may be, for example, a telescope or commercially available fiber terminator for collecting a free space propagated signal or fiber optically propagated signal, respectively. The optics associated with the receiver will be a combination of refractive or reflective elements which couple the weak input into the amplifier stage. The optical amplifier 10 receives the output from the receiver 54 and provides an output to an optical transmitter 58. The optical transmitter 58 may typically be a telescope, if free space, or fiber launcher for fiber optic based propagation. The optics associated with the transmitter is a suitable a combination of refractive or reflective elements which couple the amplified signal from the amplifier stage.

The optical communication system may be used for a number of applications. For example, it may be an optical repeater for a telecommunication system, a long distance internet communication system or short haul distribution system for connecting to individual users.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

1. A stimulated spin-flip Raman scattering optical amplifier, comprising:
a) a first control optics assembly for receiving an incoming laser beam and adjusting that incoming laser beam in accordance with first desired wavelength, polarization and beam propagation parameters;
b) a driver element for producing a driver laser beam;
c) a second control optics -assembly for receiving said driver laser beam and adjusting that driver laser beam in accordance with second desired wavelength, polarization and beam propagation parameters;
d) a spin-flip Raman active medium for receiving an output from the first control optics assembly and an output from the second control optics assembly, said spin-flip Raman active medium providing a non-linear optical interaction between said outputs such that the incoming laser beam is amplified, producing an amplified spin-flip Raman active medium output laser beam and a depleted driver laser beam; and,
e) egressing optics for receiving said amplified spin-flip Raman active medium output laser beam and said depleted driver laser beam, said egressing optics for controllably transmitting said amplified spin-flip Raman active medium output laser beam in accordance with third desired wavelength, polarization and beam propagation parameters and preventing transmission of said depleted driver laser beam, the output of said egressing optics comprising an amplified egressing optics output laser beam.

2. The optical amplifier of claim 1, wherein said first control optics assembly, comprises: a first set of serially positioned control elements for receiving the incoming laser beam, said first set of control elements comprising a first wavelength control element, a first propagation control element and a first polarization control element, said first set of control elements providing said first control optics assembly output to said spin-flip Raman active medium.

3. The optical amplifier of claim 1, wherein said second control optics assembly, comprises: a second set of serially positioned control elements for receiving the driver laser beam, said second set of control elements comprising a second wavelength control element, a second propagation control element and a second polarization control element, said second set of control elements providing said second control optics assembly output to said spin-flip Raman active medium.

4. The optical amplifier of claim 1, wherein said spin-flip Raman active medium comprises condensed matter polar crystals.

5. The optical amplifier of claim 1, wherein said spin-flip Raman active medium comprises GaP.

6. The optical amplifier of claim 1, wherein said spin-flip Raman active medium comprises LiNbO₃.

7. The optical amplifier of claim 1, wherein said spin-flip Raman active medium comprises Hg_{0.77}Cd_{0.23}Te.

8. The optical amplifier of claim 1, wherein said spin-flip Raman active medium comprises Pb_{0.88}Sn_{0.12}Te.

9. The optical amplifier of claim 1, wherein said spin-flip Raman active medium comprises periodically poled GaP.

10. The optical amplifier of claim 1, wherein said spin-flip Raman active medium comprises periodically poled LiNbO₃.

11. The optical amplifier of claim 1, wherein said spin-flip Raman active medium comprises fiber optical material.

12. The optical amplifier of claim 1, wherein said spin-flip Raman active medium possesses a frequency shift in a range of about 1 cm⁻¹ to 300 cm⁻¹.

13. An optical communication system, comprising:
a) an optical receiver for receiving an incoming laser beam and providing a receiver output;
b) a stimulated scattering optical amplifier, comprising:
i) a first control optics assembly for receiving said receiver output and adjusting that receiver output in accordance with first desired wavelength, polarization and beam propagation parameters;
ii) a driver element for producing a driver laser beam;
iii) a second control optics assembly for receiving said driver laser beam and adjusting that driver laser beam in accordance with second desired wavelength, polarization and beam propagation parameters;
iv) a spin-flip Raman active medium for receiving an output from the first control optics assembly and an output from the second control optics assembly, said spin-flip Raman active medium providing a non-linear optical interaction between said outputs such that the incoming laser beam is amplified producing an amplified spin-flip Raman active medium output laser beam and a depleted driver laser beam; and
v) egressing optics for receiving said amplified spin-flip Raman active medium output laser beam and said depleted driver laser beam, said egressing optics for controllably transmitting said amplified spin-flip Raman active medium output laser beam in accordance with third desired wavelength, polarization, and beam propagation parameters and preventing transmission of said depleted driver laser beam, the output of said egressing optics comprising an amplified egressing optics output laser beam; and,
c) a transmitter for receiving said egressing optics output laser beam and providing a transmitter output.

14. The optical communication system of claim 13, wherein said spin-flip Raman active medium comprises condensed matter polar crystals.

15. The optical communication system of claim 13, wherein said spin-flip Raman active medium comprises GaP.

16. The optical communication system of claim 13, wherein said spin-flip Raman active medium comprises LiNbO₃.

17. The optical communication system of claim 13, wherein said spin-flip Raman active medium comprises periodically poled GaP.

18. The optical communication system of claim 13, wherein said spin-flip Raman active medium comprises periodically poled LiNbO₃.

19. The optical communication system of claim 13, wherein said spin-flip Raman active medium comprises Hg_{0.77}Cd_{0.23}Te.

20. The optical communication system of claim 13, wherein said spin-flip Raman active medium comprises Pb_{0.88}Sn_{0.12}Te.

21. The optical communication system of claim 13, wherein said spin-flip Raman active medium comprises fiber optical material.

22. The optical communication system of claim 13, wherein said spin-flip Raman active medium possesses a frequency shift in a range of about 1 cm⁻¹ to 300 cm⁻¹.

23. A method for amplifying a laser beam comprising the steps of:
a) adjusting an incoming laser beam in accordance with first desired wavelength, polarization and beam propagation parameters;
b) producing a driver laser beam;
c) adjusting said driver laser beam in accordance with second desired wavelength, polarization and beam propagation parameters;
d) utilizing a spin-flip Raman active medium for receiving the adjusted incoming laser beam and said adjusted driver laser beam, said spin-flip Raman active medium providing a non-linear optical interaction between said adjusted incoming laser beams such that the incoming laser beam is amplified producing an amplified spin-flip Raman active medium output laser beam and a depleted driver laser beam; and,
f) receiving said amplified spin-flip Raman active medium output laser beam and said depleted driver laser beam, utilizing egressing optics, said egressing optics for controllably transmitting said amplified spin-flip Raman active medium output laser beam in accordance with third desired wavelength, polarization, and beam propagation parameters and preventing transmission of said depleted driver laser beam, the output of said egressing optics comprising an amplified egressing optics output laser beam.

24. The method of claim 23, wherein said step of adjusting said incoming optical laser beam comprises:
utilizing a first set of serially positioned control elements for receiving the incoming laser beam, said first set of control elements comprising a first wavelength control element, a first propagation control element and a first polarization control element, said first set of control elements providing an output to said driver element.

25. The method of claim 23, wherein said step of adjusting said incoming optical laser beam, comprises:
utilizing a second wavelength control element for receiving the driver optical wavefront; and,
utilizing a second propagation control element for receiving the output of the second wavelength control element.

26. The method of claim 23, wherein said step of utilizing a spin-flip Raman active medium comprises utilizing condensed matter polar crystals.

27. The method of claim 23, wherein said step of utilizing a spin-flip Raman active medium comprises utilizing GaP.

28. The method of claim 23, wherein said step of utilizing a spin-flip Raman active medium comprises utilizing LiNbO₃.

29. The method of claim 23, wherein said step of utilizing a spin-flip Raman active medium comprises utilizing periodically poled GaP.

30. The method of claim 23, wherein said step of utilizing a spin-flip Raman active medium comprises utilizing periodically poled LiNbO₃.

31. The method of claim 23, wherein said step of utilizing a spin-flip Raman active medium comprises utilizing fiber optical material.
